(19) United States
(12) Patent Application Publication
(10) Pub. No.: US 2019/0257910 A1
(43) Pub. Date: Aug. 22, 2019

(54) MEASURING APPARATUS USING BEACON TAG

(71) Applicant: Tae Hwi AN, Seoul (KR)

(72) Inventor: Tae Hwi AN, Seoul (KR)

(21) Appl. No.: 16/307,725

(22) PCT Filed: Jun. 12, 2017
(86) PCT No.: PCT/KR2017/006065

§ 371 Date: Dec. 6, 2018

(30) Foreign Application Priority Data
Jun. 10, 2016 (KR) 10-2016-0072783

(51) Int. Cl. G01S 1/08; G01B 7/008; G01B 7/32; G01S 11/02; G01S 17/08

(52) U.S. Cl. CPC G01S 1/08; G01B 7/008; G01S 17/08; G01S 11/02; G01B 7/32

(57) ABSTRACT

Provided is a measuring apparatus using a beacon tag. More particularly, the measuring apparatus uses a beacon tag which is simple in configuration, easy to carry and use, and has low manufacturing cost, including: three reference beacon tags arranged in a specific space; a distance measuring unit including a distance measuring sensor measuring a distance to a target, a measurement direction detection unit detecting a measurement direction of the distance measuring sensor, and a measuring beacon tag provided in a low part of the distance measuring sensor; a position detection unit: calculating relative coordinates of the measuring beacon tag; and detecting relative coordinates of the target on the basis of the relative coordinates of the measuring beacon tag, the distance between the target and the distance measuring sensor, and the measurement direction of the distance measuring sensor.

### TECHNICAL FIELD

The present invention relates to a measuring apparatus using a beacon tag. More particularly, the present invention relates to a measuring apparatus using a beacon tag which is simple in configuration, easy to carry and use, and has low manufacturing cost.

### BACKGROUND ART

In general, a laser distance measuring apparatus is mainly used for a distance measuring apparatus. A laser distance measuring apparatus is an apparatus that outputs laser to a target whereby which a distance is measured; measures a time taken for the output laser to be reflected and returned to the apparatus; and transforms the time into a distance such that a measurer visually checks the distance. Patent documents 0001 to 0005 disclose the same (Refer to below).

—Below—

(Patent document 1) (0001) Korean Patent No. 0585558B1 (2006 May 25)

(Patent document 2) (0002) Korean Patent No. 0902043 (2009 Jun. 3)

(Patent document 3) (0003) Japanese Patent No. 5-139907 (1995 Jun. 2)

(Patent document 4) (0004) Japanese Patent No. 1994-138231 (1994 May 20)

(Patent document 5) (0005) US Patent No. 2014-0320844 (2014 Oct. 30)

Such a distance measuring apparatus is for measuring a distance between the distance measuring apparatus and a target. In order to measure a distance between two points far from the distance measuring apparatus, the distance measuring apparatus has to be moved to any one of the two points and then measuring is performed.

However, in an environment where moving a distance measuring apparatus is difficult such as a construction site, a building with a high position, or a space between narrow walls, there are some inconveniences to measure a distance using a conventional distance measuring apparatus, or measuring a distance may be impossible. In detail, in order to measure a floor area of a building, a distance between vertices of adjacent to walls has to be measured. However, in such a case, distance measuring is impossible since disposing the distance measuring apparatus on the vertex of the wall is impossible due to the wall and focusing laser of the distance measuring apparatus from the one vertex to the other vertex is impossible in terms of an angle.

In addition, a conventional distance measuring apparatus is limited in use since measuring an area and a volume is not possible by using the same in addition to distance measuring.

Meanwhile, a three-dimensional position measuring device (laser tracker) may identify a distance between two points at a measurement position. However, a large time and procedures are required since all environments nearby the three-dimensional position measuring device have to be scanned. In addition, moving the same is not easy due to characteristics of the same, and portability thereof is not good. In addition, the device has large power consumption, and is sensitive to the environment, so the device can only be used within a building. Accordingly, using the device outdoors such as construction sites is inappropriate.

### DISCLOSURE

### Technical Problem

Accordingly, the present invention has been made keeping in mind the above problems occurring in the prior art, and an object of the present invention is to provide a measuring apparatus using a beacon tag which is simple in configuration, easy to carry and use, and has low manufacturing cost so as to be widely used without limit in places such as constructions sites.

### Technical Solution

In order to accomplish the above object, the present invention provides a measuring apparatus using beacon tag, the apparatus including:

three reference beacon tags arranged in a specific space;

a distance measuring unit including a distance measuring sensor measuring a distance to a target, a measurement direction detection unit detecting a measurement direction of the distance measuring sensor, and a measuring beacon tag provided in a low part of the distance measuring sensor;

a position detection unit: calculating relative coordinates of the measuring beacon tag by using a triangulation method on the basis of strength of respective received signals of the three reference beacon tags and the measuring beacon tag; and detecting relative coordinates of the target on the basis of the relative coordinates of the measuring beacon tag, the distance between the target and the distance measuring sensor, and the measurement direction of the distance measuring sensor; and

a distance calculating unit calculating a distance between two targets on the basis of the relative coordinates of the two targets which are detected by the position detection unit.

In addition, the present invention provides a measuring apparatus using beacon tag, the apparatus including: three reference beacon tags arranged in a specific space;

a distance measuring unit including a distance measuring sensor measuring a distance to a target, a measurement direction detection unit detecting a measurement direction of the distance measuring sensor, and a measuring beacon tag provided in a low part of the distance measuring sensor;

a position detection unit: calculating relative coordinates of the measuring beacon tag by using a triangulation method on the basis of strength of respective received signals of the three reference beacon tags and the measuring beacon tag; and detecting relative coordinates of the target on the basis of the relative coordinates of the measuring beacon tag, the distance between the target and the distance measuring sensor, and the measurement direction of the distance measuring sensor; and

an area calculating unit measuring an area configured with at least three targets on the same plane on the basis of three relative coordinates of the at least three targets which are detected by the position detection unit.

In addition, the present invention provides a measuring apparatus using beacon tag, the apparatus including: three reference beacon tags arranged in a specific space;

a distance measuring unit including a distance measuring sensor measuring a distance to a target, a measurement direction detection unit detecting a measurement direction of the distance measuring sensor, and a measuring beacon tag provided in a low part of the distance measuring sensor;

a position detection unit: calculating relative coordinates of the measuring beacon tag by using a triangulation method on the basis of strength of respective received signals of the three reference beacon tags and the measuring beacon tag; and detecting relative coordinates of the target on the basis of the relative coordinates of the measuring beacon tag, the distance between the target and the distance measuring sensor, and the measurement direction of the distance measuring sensor; and

a volume calculating unit calculating a volume configured with at least three targets positioned on the same plane, and at least one target positioned on a plane different from the plane where the at least three targets are position on the basis of respective relative coordinates of at least four targets which are detected by the distance measuring unit and the position detection.

Each of the three reference beacon tags may be separately provided or may be arranged in a triangle form within a single housing.

The measurement direction detection unit may be configured with a tri-axial angle sensor, or with an auxiliary beacon tag provided in a low part of the measuring beacon tag.

Particularly, when the auxiliary beacon tag is used as the measurement direction detection unit, it is preferable for the measuring beacon tag and the auxiliary beacon tag to be disposed on a measurement axis of the distance measuring sensor.

It is preferable for the distance measuring sensor to be configured with a laser emitting unit outputting laser to a target, and a laser receiving unit receiving the laser output from the laser emitting unit and reflected by the target.

In addition, the position detection unit may be configured within the distance measuring unit.

In addition, the distance measuring unit may be connected to an additional terminal in a wireless or wired manner, and the position detection unit may be disposed within the additional terminal.

### Advantageous Effects

A measuring apparatus using a beacon tag of the present invention is simple in configuration, easy to carry and use, and has low manufacturing cost so as to be widely used without limit in places such as constructions sites. Particularly, when measuring an area of a floor area of a construction site or building, a distance, an area, and a volume between specific targets can be measured by measuring a distance by focusing a distance measuring unit to the specific targets while three reference beacon tags are arranged nearby the specific targets whereby a distance is measured and which are positioned at vertices of neighbor walls.

Particularly, a measuring apparatus using a beacon tag of the present invention can simply measure a distance between two targets by respectively detecting relative coordinates of the two targets by using a distance measuring unit.

In addition, a measuring apparatus using a beacon tag of the present invention can simply measure an area of at least three targets that are on the same plane by respectively detecting relative coordinates of the at least three targets by using a distance measuring unit.

A measuring apparatus using a beacon tag of the present invention can simply measure a volume of at least three targets that are on the same plane and at least one target that is on a plane different from the plane where the at least three targets are positioned by respectively detecting relative coordinates of the above targets by using a distance measuring unit.

### DESCRIPTION OF DRAWINGS

FIG. 1 is a view schematically showing a measuring apparatus using a beacon tag of the present invention.

FIG. 2 is a view schematically showing a form of three reference beacon tags.

FIG. 3 is a block diagram schematically showing a configuration of a distance measuring unit.

FIG. 4 is a view schematically showing a planar state of a distance measuring unit.

FIG. 5 is a block diagram schematically showing another configuration of a distance measuring unit.

FIG. 6 is a view schematically showing a state where a position detection unit is provided to an additional terminal.

FIG. 7 is a view showing a method of calculating relative coordinates of a measuring beacon tag by using a triangulation method.

FIG. 8 is a view schematically showing a state where a distance and direction with a target are measured by using a distance measuring unit.

FIG. 9 is a view showing a method of calculating relative coordinates of a target.

FIG. 10 is a view schematically showing a state where a distance is measured by using a measuring apparatus using a beacon tag of the present invention.

FIG. 11 is a view schematically showing a state where an area is measured by using a measuring apparatus using a beacon tag of the present invention.

FIG. 12 is a view schematically showing a state where a volume is measured by using a measuring apparatus using a beacon tag of the present invention.

### BEST MODE

Hereinafter, a measuring apparatus using a beacon tag of the present invention will be described in detail with reference to the drawings, and the scope of the present invention is not limited to the following embodiments.

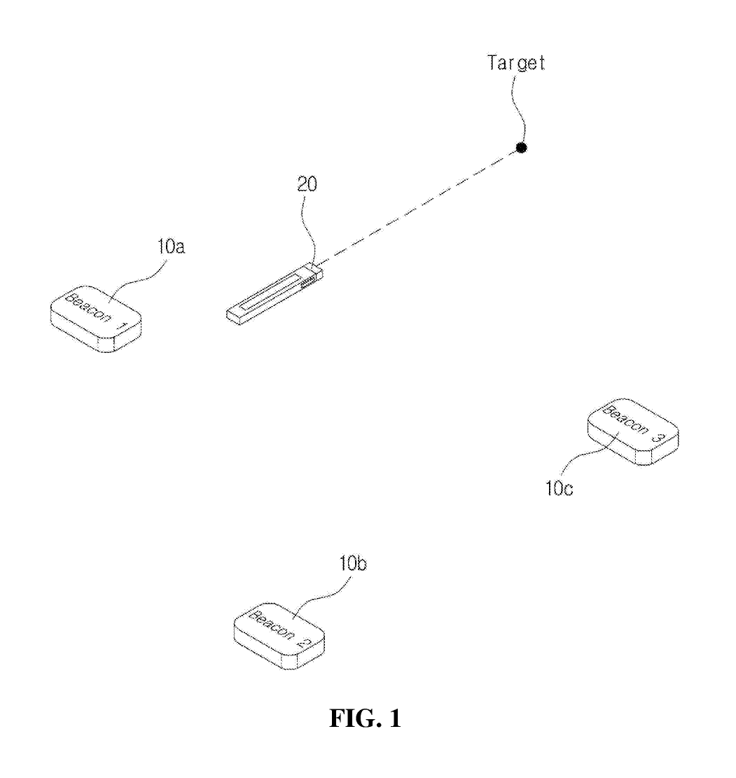

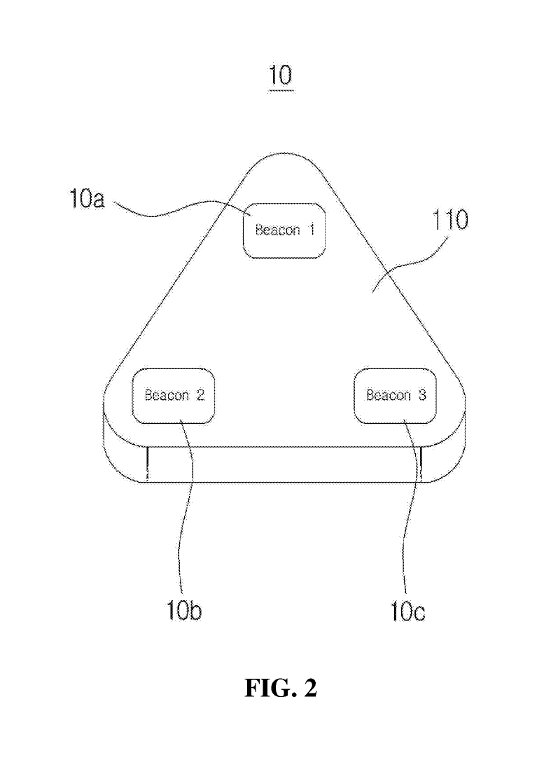

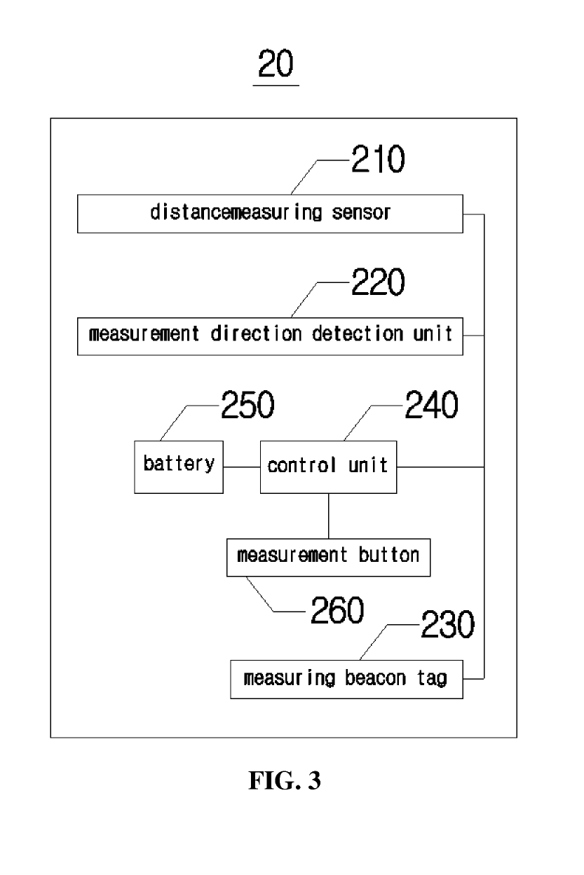

FIG. 1 is a view schematically showing a measuring apparatus using a beacon tag of the present invention, FIG. 2 is a view schematically showing a state where three reference beacon tags 10a, 10b, and 10c are provided within a single housing, and FIG. 3 is a block diagram schematically showing a configuration of a distance measuring unit 20.

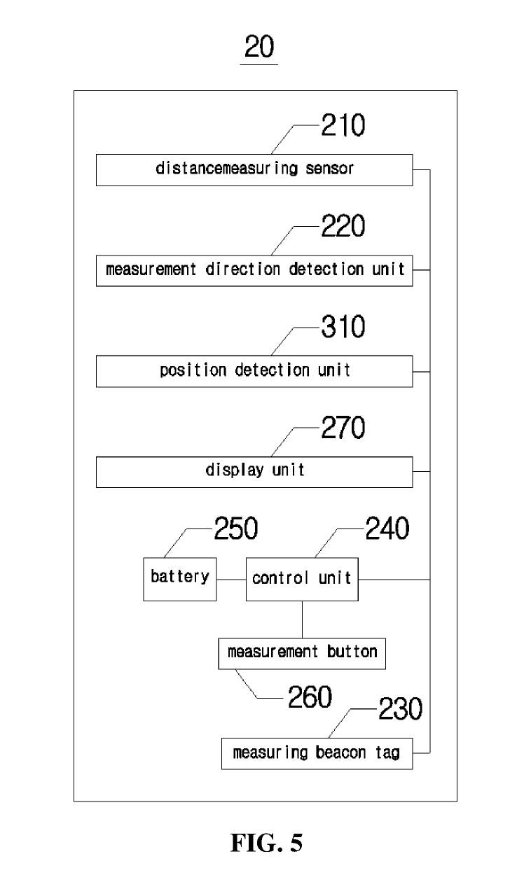

A measuring apparatus using a beacon tag of the present invention is configured with, as shown in FIG. 1, three reference beacon tags 10a, 10b, and 10c, a distance measuring unit 20, and a position detection unit (310 of FIG. 5).

First, the three reference beacon tags 10a, 10b, and 10c are for calculating relative coordinates of a measuring beacon tag 230 of the distance measuring unit 20 on the basis of received intensity of the measuring beacon tag 230 by using a triangulation method. Each of the three reference beacon tags 10a, 10b, and 10c is configured with a wireless module, a control unit controlling the wireless module, and a battery supplying power to the wireless module and the control unit.

The wireless module refers to a low power near field wireless communication device such as Bluetooth, Zigbee, etc. In addition, the wireless module periodically transmits a wireless signal according to a control of the control unit, and the wireless signal includes unique information of the corresponding wireless module. The unique information is for distinguishing each of the three reference beacon tags 10a, 10b, and 10c, and is a serial number including an UUID (universal unique identifier) of the wireless module integrated in each reference beacon tag.

Meanwhile, the three reference beacon tags 10a, 10b, and 10c may be disposed nearby a target to be measured by being separately provided as shown in FIG. 1.

In addition, the three reference beacon tags 10a, 10b, and 10c may be configured by arranging the same in a triangle form within a single housing as shown in FIG. 2 so as to improve user convenience and portability. Herein, in the housing, the control unit for controlling the three reference beacon tags 10a, 10b, and 10c, and the battery are provided.

Further, it is preferable that the three reference beacon tags 10a, 10b, and 10c are configured in a structure where a housing 110 is possibly fastened to footwear of a user so as to improve user convenience and portability. For example, the housing 110 may be fastened to the footwear of the user by using a fastening means such as rubber band, Velcro, etc.

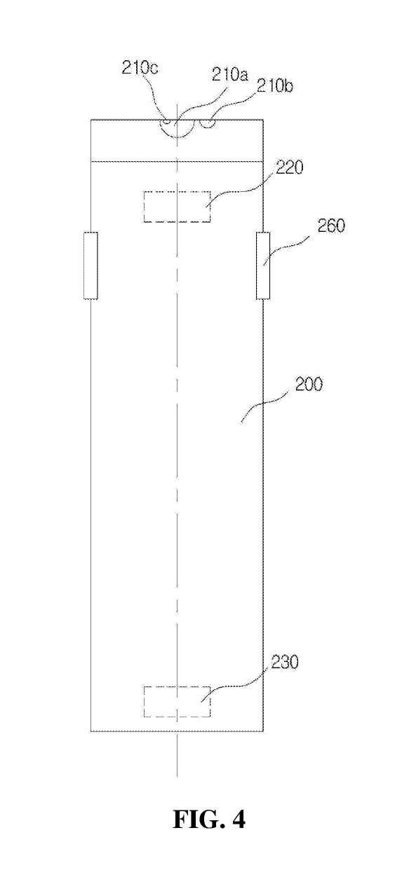

FIG. 4 is a view schematically showing a state where a measurement direction detection unit and a measuring beacon tag of the distance measuring unit 20 are arranged.

The distance measuring unit 20 is configured with, as shown in FIGS. 3 and 4, a distance measuring sensor 210 measuring a distance to a target, a measurement direction detection unit 220 measuring a measurement direction of the distance measuring sensor 210, a measuring beacon tag 230 provided in a lower part of the distance measuring sensor 210, a control unit 240 controlling the distance measuring sensor 210, the measurement direction detection unit 220, and the measuring beacon tag 230, and a battery 250 for supplying power.

The distance measuring sensor 210, the measurement direction detection unit 220, and the distance measuring sensor 210 are provided within a housing 200. The housing 200 is not limited in a form, and may have a rectangular parallelepiped shape elongated in a vertical direction.

The distance measuring sensor 210 is provided in an upper part of the housing 200 to face a target, and is configured with a laser emitting unit 210a outputting laser to a target, and a laser receiving unit 210b receiving laser that is output from the laser emitting unit 210a and reflected by the target. In addition, it is preferable to additionally provide a visible ray emitting unit 210c in the distance measuring sensor 210 such that it is possible for the user to visually check whether or not the distance measuring unit 20 is accurately focused on the target.

In addition, the measurement direction detection unit 220 is for detecting a measurement direction of the distance measuring sensor 210, that is, a direction of the housing 200. The measurement direction detection unit 220 may be configured with a tri-axial angle sensor possibly measuring a tri-axial slope, or with an auxiliary beacon tag.

The measuring beacon tag 230 detects intensity of respective received signals of the three reference beacon tags 10a, 10b, and 10c, and calculates relative coordinates of the distance measuring unit 20 by using a triangulation method on the basis of the intensity of the received signals. The measuring beacon tag 230 is disposed on a measurement axis of the distance measuring sensor 210 as shown in FIG. 4.

Particularly, when the auxiliary beacon tag is used as the measurement direction detection unit 220, the measuring beacon tag 230 and the auxiliary beacon tag are disposed on a measurement axis of the distance measuring sensor 210 as shown in FIG. 4. Herein, in order to accurately measure a measurement direction of the distance measuring unit 20, it is preferable for the measuring beacon tag 230 and the auxiliary beacon tag to be spaced apart within the housing as possible. For example, when the measuring beacon tag 230 is disposed in a lower part of the housing 200, the auxiliary beacon tag 220 may be disposed in an upper part of the housing 200, or vice-versa.

A method of detecting a measurement direction of the distance measuring unit 20 by using the auxiliary beacon tag: calculates relative coordinates of the auxiliary beacon tag on the basis of strength of respective received signals of the auxiliary beacon tag and the three reference beacon tags 10a, 10b, and 10c; and detects a measurement direction of the distance measuring unit 20 by comparing the relative coordinates of the auxiliary beacon tags with relative coordinates of the measuring beacon tag 230.

Meanwhile, in the housing 200, a measurement button 260 is provided for operating the distance measuring sensor 210 so as to measure a distance to a target.

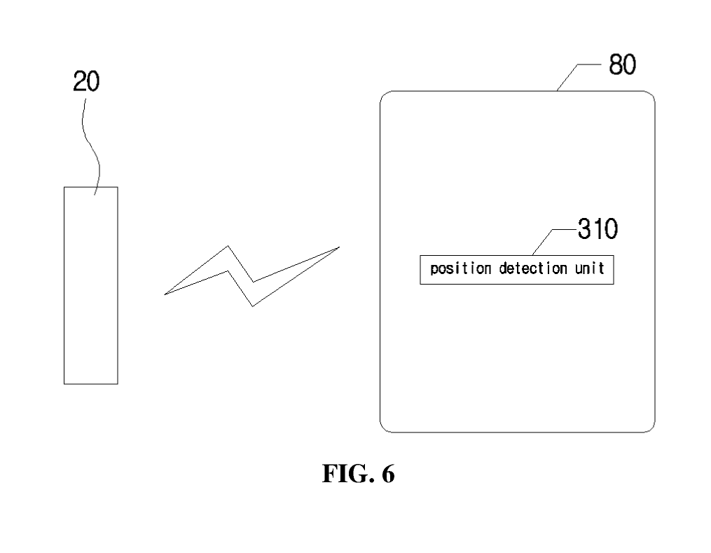

FIG. 5 is a block diagram schematically showing the distance measuring unit provided with a position detection unit, and FIG. 6 is a view schematically showing a terminal provided with a position detection unit, and a distance measuring unit.

Subsequently, a position detection unit 310 detects relative coordinates of a target on the basis of relative coordinates of the measuring beacon tag 230, a distance between the target and the distance measuring sensor 210, and a measurement direction of the distance measuring sensor 210.

Relative coordinates of the measuring beacon tag 230 are measured by using a triangulation method on the basis of strength of respective received signals of the three reference beacon tags 10a, 10b, and 10c, and the measuring beacon tag 230. In other words, measuring is performed on the basis of strength of respective received signals between the three reference beacon tags 10a, 10b, and 10c, and strength of respective received signals between the three reference beacon tags 10a, 10b, and 10c, and the measuring beacon tag 230.

In addition, a distance between the target and the distance measuring sensor 210 is measured by the distance measuring sensor 210, and a measurement direction of the distance measuring sensor 210 is detected by the measurement direction detection unit 220 of the distance measuring unit 20.

Meanwhile, when measuring relative coordinates of a target, the same may be determined by using at least of the three reference beacon tags 10a, 10b, and 10c as a reference point.

The position detection unit 310 may be provided inside the distance measuring unit 20 as shown in FIG. 5. When the position detection unit 310 is provided within the distance measuring unit 20, a display unit 270 may be provided such that a user checks relative coordinates of a target. In the display unit 270, relative coordinates of the target which is measured by the position detection unit 310 are displayed.

In addition, the position detection unit 310 may be configured with an additional terminal such as a smartphone, a smart pad, etc. as shown in FIG. 6. Herein, it is preferable to connect the distance measuring unit 20 and the position detection unit 310 by using a near filed wireless communication device such as WiFi, Bluetooth, Zigbee, etc.

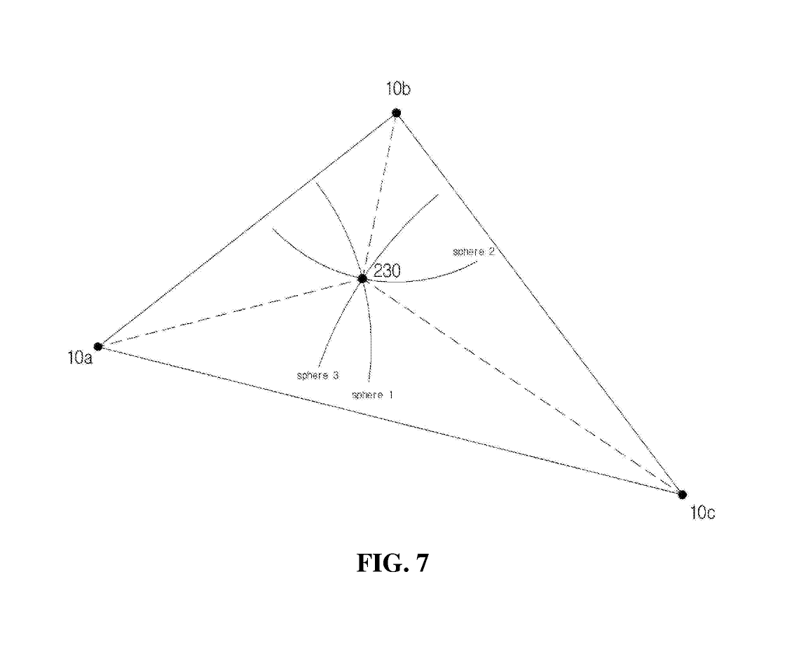

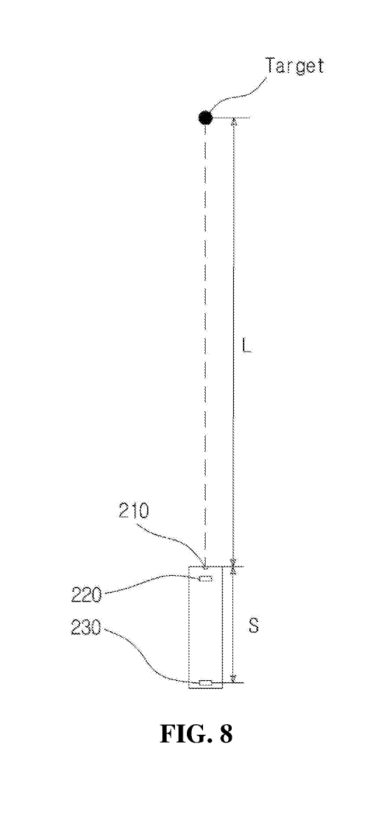

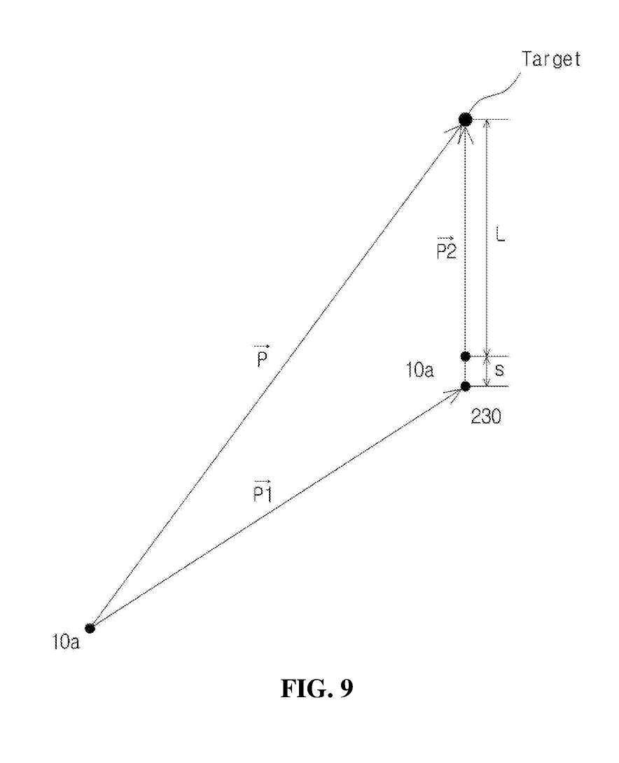

FIG. 7 is a view showing a method of calculating relative coordinates of a measuring beacon tag by using a triangulation method, FIG. 8 is a view schematically showing a state where a distance to a target and a measurement direction are measured by using the distance measuring unit, and FIG. 9 a view showing a method of calculating relative coordinates of a target.

By using strength of respective received signals of the three reference beacon tags 10a, 10b, and 10c and a measuring beacon tag 230, as shown in FIG. 7, relative coordinates (XYZ coordinates) of the measuring beacon tag based on an arbitrary reference point may be calculated by calculating, by using an algorithm, coordinates where three spheres overlap which are: 1) a first sphere having a radius based on received signal intensity between a first reference beacon tag 10a and the measuring beacon tag, and the first reference beacon tag 10a being the center; 2) a second sphere having a radius based on received signal intensity between a second reference beacon tag 10b and the measuring beacon tag, and the second reference beacon tag 10b being the center; and 3) a third sphere having a radius based on received signal intensity between a third reference beacon tag 10c and the measuring beacon tag, and the third reference beacon tag 10c being the center.

Herein, an arbitrary reference point is a position of any one of the three reference beacon tags. For example, when a position of the first reference beacon tag 10a is set as a reference point, coordinates of the first reference beacon tag 10a becomes (0,0,0).

In addition, as shown in FIG. 8, a distance between a measuring beacon tag and a target, and a measurement direction of the distance measuring unit may be measured by using the distance measuring unit. A distance between the measuring beacon tag and the target corresponds to the sum of a distance L between the distance measuring sensor and the target, and a distance S between the distance measuring sensor and the measuring beacon tag. In addition, a measurement direction of the distance measuring unit is possibly measured by using the measurement direction detection unit.

A vector \vec{P} of the target in a first reference beacon tag 10a may be calculated by the sum of a vector \vec{P1} of the measuring beacon tag in the first reference beacon tag 10a that is the arbitrary reference point, and a vector \vec{P2} of the target in the measuring beacon tag. Relative coordinates of the target may be calculated by using the \vec{P}.

Relative coordinates of the target may be detected on the basis of relative coordinates of the measuring beacon tag of the distance measuring unit which is calculated as above, a distance between the target and the distance measuring sensor which is measured by the distance measuring unit, and a measurement direction of the distance measuring sensor.

A measuring apparatus using a beacon tag of the present invention possibly simply measures relative coordinates of a specific target by measuring a distance by using the distance measuring unit 20 by focusing the same on the specific target under a state where three reference beacon tags 10a, 10b, and 10c are arranged nearby the specific target when the user wants to measure relative coordinates of the specific target from a reference point.

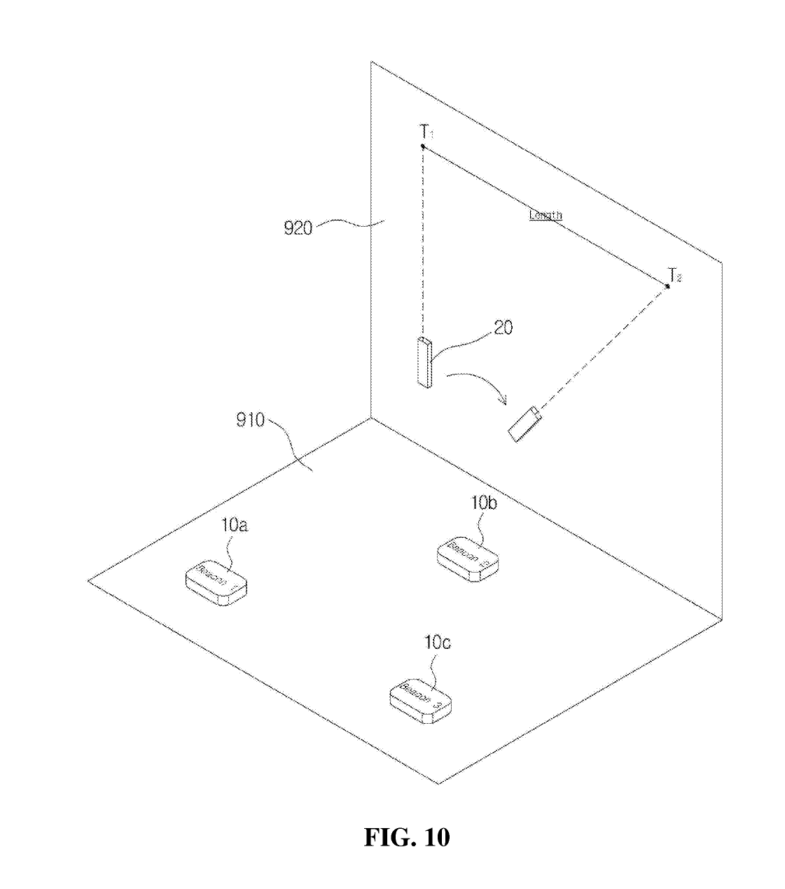

FIG. 10 is a view schematically showing a state where a distance is measured by using a measuring apparatus using a beacon tag of the present invention.

A measuring apparatus using a beacon tag of the present invention is configured with three reference beacon tags 10a, 10b, and 10c, a distance measuring unit 20, a position detection unit 310, and a distance calculating unit.

The three reference beacon tags 10a, 10b, and 10c, the distance measuring unit 20, and the position detection unit 310 are respectively identical to the three reference beacon tags 10a, 10b, and 10c, the distance measuring unit 20, and the position detection unit 310 of the target position detection apparatus, and thus detailed descriptions thereof will be omitted.

When distances are respectively measured by focusing the distance measuring unit 20 to a first target T1 and a second target T2 whereby distances are measured, the position detection unit 310 detects relative coordinates of the first target and relative coordinates of the second target. The distance calculating unit calculates a distance between the relative coordinates of the first target and the relative coordinates of the second target which are detected by using the position detection unit 310.

Meanwhile, the distance calculating unit may be provided within the distance measuring unit 20 with the position detection unit 310, or may be provided in an additional terminal with the position detection unit 310.

As described above, a distance between the first target and the second target may be simply measured by operating the distance measuring unit 20 two times.

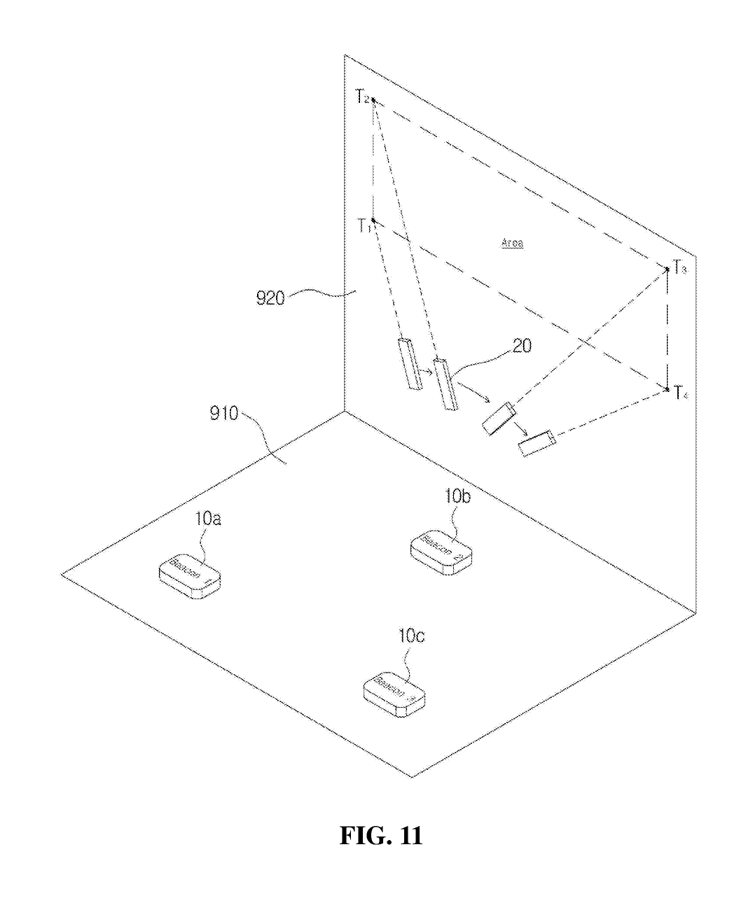

FIG. 11 is a view schematically showing a state where an area is measured by using a measuring apparatus using a beacon tag of the present invention.

A measuring apparatus using a beacon tag of the present invention is configured with three reference beacon tags 10a, 10b, and 10c, a distance measuring unit 20, a position detection unit 310, and an area calculating unit.

The three reference beacon tags 10a, 10b, and 10c, the distance measuring unit 20, and the position detection unit 310 are respectively identical to the three reference beacon tags 10a, 10b, and 10c, the distance measuring unit 20, and the position detection unit 310 of the target position detecting apparatus, and thus detailed descriptions thereof will be omitted.

When measuring an area of a specific area by using the measuring apparatus using the beacon tag, distances are sequentially measured by performing focusing on each vertex of the specific area. For example, when a surface to be measured has a triangle form, a number of targets becomes three. As shown in FIG. 9, when a surface to be measured is a rectangle, a number of targets becomes four.

When the distance measuring unit 20 sequentially measures distances by focusing the same on a first target T1, a second target T2, a third target T3, and a fourth target T4, respective relative coordinates of the first target T1, the second target T2, the third target T3, and the fourth target T4 are detected by the position detection unit 310.

The area calculating unit calculates an area of a surface to be measured on the basis of the respective relative coordinates of the first target T1, the second target T2, the third target T3, and the fourth target T4 which are detected by the position detection unit 310.

Meanwhile, the area calculating unit may be provided within the distance measuring unit 20 with the position detection unit 310, or may be provided in an additional terminal with the position detection unit 310.

As described above, an area of a surface to be measured may be simply measured by operating the distance measuring unit 20 three times.

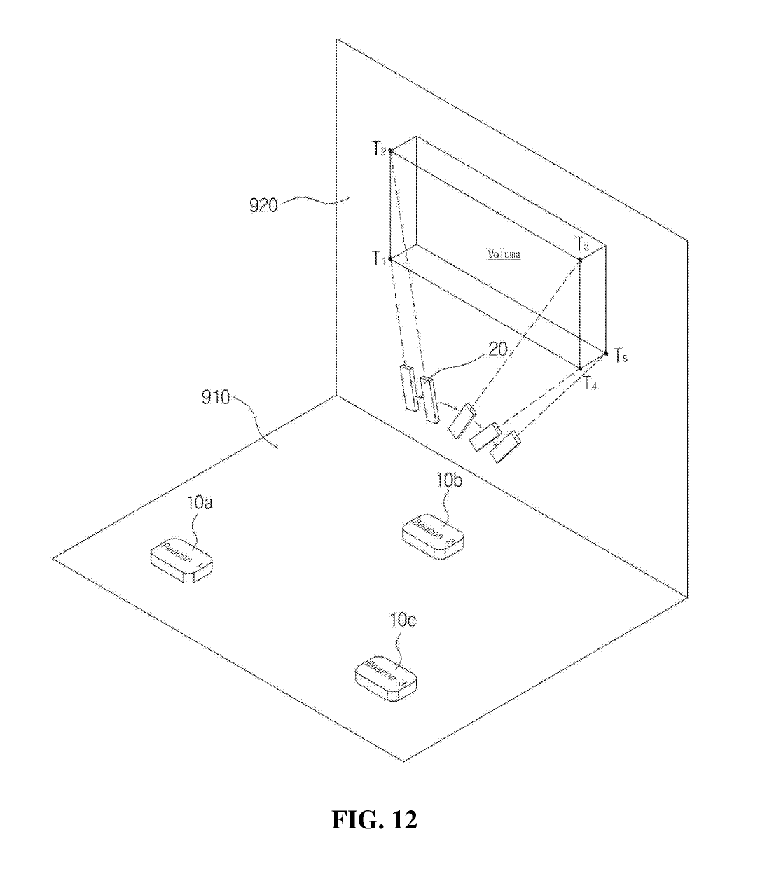

FIG. 12 is a view schematically showing a state where a volume is measured by using a measuring apparatus using a beacon tag of the present invention.

A measuring apparatus using a beacon tag of the present invention is configured with three reference beacon tags 10a, 10b, and 10c, a distance measuring unit 20, a position detection unit 310, and a volume calculating unit.

The three reference beacon tags 10a, 10b, and 10c, the distance measuring unit 20, and the position detection unit 310 are respectively identical to the three reference beacon tags 10a, 10b, and 10c, the distance measuring unit 20, and the position detection unit 310 of the target position detecting apparatus, and thus detailed descriptions thereof will be omitted.

When measuring a volume of a specific object or a specific space by using the measuring apparatus using the beacon tag, distances are sequentially measured by performing focusing on at least three targets on the same plane, and on at least one target positioned on a plane different from the plane where the three targets are positioned.

For example, in case of a rectangular parallelepiped as shown in FIG. 12, first, distances are sequentially measured by performing focusing on vertices on the same plane which are a first target T1, a second target T2, a third target T3, and a fourth target T4. Subsequently, a distance is measured by performing focusing on a fifth target T5 on another plane.

When the distance measuring unit 20 sequentially measures distances by focusing the same on the first target T1, the second target T2, the third target T3, the fourth target T4, and the fifth target T5, the position detection unit 310 detects respective relative coordinates of the first target T1, the second target T2, the third target T3, the fourth target T4, and the fifth target T5.

The volume calculating unit calculates a volume of an object to be measured which has a rectangular parallelepiped form on the basis of the respective relative coordinates of the first target T1, the second target T2, the third target T3, the fourth target T4, and the fifth target T5 which are measured by the position detection unit 310.

Meanwhile, the volume calculating unit may be provided within the distance measuring unit 20 with the position detection unit 310, or may be provided in an additional terminal with the position detection unit 310.

As described above, a volume of an object may be simply measured by operating the distance measuring unit 20 at least four times when an object for which a volume is measured is a triangular pyramid and a triangular pillar form, and five times when an object is a rectangular parallelepiped form.

### INDUSTRIAL APPLICABILITY

A measuring apparatus using a beacon tag of the present invention has a simple configuration, is easy to use and carry on, has low manufacturing cost, and can be widely used without being limited to the place of use such as a construction site. Particularly, when measuring an area of a floor area of a construction site or building, a distance, an area, and a volume between specific targets may be measured by measuring a distance by focusing a distance measuring unit to the specific targets while three reference beacon tags are arranged nearby the specific targets whereby a distance is measured and which are positioned at vertices of neighbor walls.

Particularly, a measuring apparatus using a beacon tag of the present invention may simply measure a distance between two targets by respectively detecting relative coordinates of the two targets by using a distance measuring unit.

In addition, a measuring apparatus using a beacon tag of the present invention can simply measure an area for at least three targets that are on the same plane by respectively detecting relative coordinates of the at least three targets by using a distance measuring unit.

A measuring apparatus using a beacon tag of the present invention can simply measure a volume configured with at least three targets that are on the same plane and a at least one target that is on a plane different from the plane where the at least three targets are positioned by respectively detecting relative coordinates of the above targets by using a distance measuring unit.

1. A measuring apparatus using beacon tag, the apparatus comprising:
three reference beacon tags arranged in a specific space;
a distance measuring unit including a distance measuring sensor measuring a distance to a target, a measurement direction detection unit detecting a measurement direction of the distance measuring sensor, and a measuring beacon tag provided in a low part of the distance measuring sensor;
a position detection unit: calculating relative coordinates of the measuring beacon tag by using a triangulation method on the basis of strength of respective received signals of the three reference beacon tags and the measuring beacon tag; and detecting relative coordinates of the target on the basis of the relative coordinates of the measuring beacon tag, the distance between the target and the distance measuring sensor, and the measurement direction of the distance measuring sensor; and
a distance calculating unit calculating a distance between two targets on the basis of relative coordinates of the two targets which are detected by the position detection unit.

2. A measuring apparatus using beacon tag, the apparatus comprising:
three reference beacon tags arranged in a specific space;
a distance measuring unit including a distance measuring sensor measuring a distance to a target, a measurement direction detection unit detecting a measurement direction of the distance measuring sensor, and a measuring beacon tag provided in a low part of the distance measuring sensor;
a position detection unit: calculating relative coordinates of the measuring beacon tag by using a triangulation method on the basis of strength of respective received signals of the three reference beacon tags and the measuring beacon tag; and detecting relative coordinates of the target on the basis of the relative coordinates of the measuring beacon tag, the distance between the target and the distance measuring sensor, and the measurement direction of the distance measuring sensor; and
an area calculating unit measuring an area configured with at least three targets on the same plane on the basis of three relative coordinates of the at least three targets which are detected by the position detection unit.

3. A measuring apparatus using beacon tag, the apparatus comprising:
three reference beacon tags arranged in a specific space;
a distance measuring unit including a distance measuring sensor measuring a distance to a target, a measurement direction detection unit detecting a measurement direction of the distance measuring sensor, and a measuring beacon tag provided in a low part of the distance measuring sensor;
a position detection unit: calculating relative coordinates of the measuring beacon tag by using a triangulation method on the basis of strength of respective received signals of the three reference beacon tags and the measuring beacon tag; and detecting relative coordinates of the target on the basis of the relative coordinates of the measuring beacon tag, the distance between the target and the distance measuring sensor, and the measurement direction of the distance measuring sensor; and
a volume calculating unit calculating a volume configured with at least three targets positioned on the same plane, and at least one target positioned on a plane different from the plane where the at least three targets are positioned on the basis of respective relative coordinates of the at least four targets which are detected by the distance measuring unit and the position detection.

4. The measuring apparatus of claim 1, wherein each of the three reference beacon tags is separately provided.

5. The measuring apparatus of claim 1, wherein the three reference beacon tags are arranged in a triangle form within a single housing.

6. The measuring apparatus of claim 1, wherein the measurement direction detection unit is configured with an auxiliary beacon tag provided in a low part of the measuring beacon tag.

7. The measuring apparatus of claim 6, wherein the measuring beacon tag and the auxiliary beacon tag are disposed on a measurement axis of the distance measuring sensor.

8. The measuring apparatus of claim 1, wherein the position detection unit is disposed within the distance measuring unit.

9. The measuring apparatus of claim 1, wherein the distance measuring unit is connected to an additional terminal in a wireless or wired manner, and the position detection unit is disposed within the additional terminal.
